(19) United States
(12) Patent Application Publication
(10) Pub. No.: US 2001/0049789 A1
(43) Pub. Date: Dec. 6, 2001

(54) METHOD FOR THE SECURE DISPLAY DURING TRANSMISSION OF DATA OR DATA FILES BETWEEN USERS

(76) Inventor: KURT SCHMID, OBERURSEL (DE)

Correspondence Address: HORST M. KASPER, 13 FOREST DRIVE, WARREN, NJ, 07059

(21) Appl. No.: 09/094,710

(22) Filed: Jun. 15, 1998

(30) Foreign Application Priority Data
Jun. 13, 1997 (DE) 197 25 167.6

(51) Int. Cl. H04L 9/00

(52) U.S. Cl. 713/180

(57) ABSTRACT

A method is provided for a secure transfer of data or data files between participants, subscribers, and users. A first graphic image of the first original form is generated from the first original form of the data file or of the data by a first transformation process. A second electronic seal is generated from the first graphic image in a second step. In the following, the first original form of the data file or of the data and the second electronic seal of the graphic image are transmitted to a receiver. In a further step, the receiver generates a second graphic image of the original form, received at the receiver, with the same transformation process. The receiver generates a fourth electronic seal from the second graphic image, generated by the second transformation process. The transmitted second seal and the newly generated fourth seal are compared to each other with respect to identity in a last step.

### BACKGROUND OF THE INVENTION

1. Field of the Invention

The invention relates to a method for the safe display during transfer of data or data files between participants, users, and/or subscribers.

2. Brief Description of the Background of the Invention Including Prior Art

Sensitive data, data sources, and data files are present in the most varied fields of application in data processing. These application fields can include data and/or data sources from data bases, display information, online information, multi-media applications, online transactions and similar programs for the data processing in object code or source code or any other sensitive data. The invention described in detail in the following is not limited to any specific type of data or data file.

It has been known for quite some time to encode data, or data sources or data files having a sensitive content. It is assured with different known encoding methods, having differing quality levels, that unauthorized third parties cannot understand such data, data sources or data files.

Additional different security requirements are imposed on the transmission during the transmission of sensitive data or data files depending on the type of the sensitive data or data files. It can be important

a) that the allocation by the electronic “signature” is conclusive between an object, i.e. data source or data file or data item, and a subject, i.e. person and/or computer;

b) that it is assured that the sent data and/or data sources files are consistent with and match the data and/or data files which have been received as to its content up to the last bit, in other words unchanged, and/or

c) that it is assured during the transmission of two data files, two data items, or one data file and one data item, which have in each case a defined relationship between each other, that this relationship remains present in its unchanged form also after the transmission. Such a connection would for example be an electronic signature to a data file of a data time. In this case it has to be assured during the transmission that the electronic signature is placed “under” those data and/or data files, which are to carry the electronic signature according to the opinion of the “signatory”, i.e. that not totally different data and/or data files are provided with this electronic signature, and/or

d) that the applied method for identifying sensitive data, data sources and/or files was not changed within the framework of the execution of the method, i.e. that the sender and the receiver operate with the identical method such that it is assured that sensitive data sources and data files are not changed by a change of the method in an undesired way and/or

e) that it is assured that the data source or data file content, such as it is presented to the viewer on the screen, is identical in its contents to the actual data source or data file, i.e. that hidden data file contents or data, not shown on the screen, as well as hidden connections to one or more other data sources or data files are missing such that the actual data source and or data file content, under consideration of all connections, is (not) larger or (not) different than that, which is presented to the viewer on the screen.

The usual operating systems make available the size of a data file expressed in bytes as information relating to the size of the data file or of the data. Two identical data files or identical data therefore have to exhibit the same number of bytes. Vice versa, however, the same number of bytes does not necessarily mean an identity of two data sources, data files or of two data sets.

For these reasons, methods have been developed in order to be able to determine with a high degree of probability the identity of data sources and of data files or of data based on quantitative criteria.

The most widely used methods in this context are check sum procedures.

The quality of such methods varies over a wide range. For example, methods are known, wherein only the blocks, occupied on the concrete data carrier for a concrete data source or data file, are counted and their sums are employed as a comparison number and reference value. This test procedure contains of course no indications relating to the contents of the data blocks, it is even ambiguous if each block has been completely defined, read, or recorded. Small deviations relative to the length of the data set or data file, as long as the total number of blocks is not changed by these deviations, are not recognized by such test procedures.

Better check sum procedures are among others the cyclic redundancy check (CRC).

The probably most widely used such methods are the hash functions.

Cryptographic methods can assure with highest security the identity of data sources and of data by the generation of electronic seals in contrast to the mere error recognition in the check sum procedure. Electronic seals can be generated in the following way:

1. According to methods, such as for example the message authentication code (MAC), the electronic seals are directly generated or verified from data sets, data sources or data files by taking into consideration a code key.

2. The electronic seal can be generated based on the mechanism of a hash code and an electronic signature as follows:

a. Generation of a cryptographic check sum from the respective data set, data sources and/or data files, for example through a hash function. Contents and not fixed blocks are tested with the hash functions. The freedom of collision is the most important requirement to a hash function. It is required in this context that it should not be possible after a malicious change of a data source or data file to obtain the same hash value as was present prior to the manipulation. Vice versa, no document can be generated to a predetermined hash value, which document would generate this hash value.

b. Calculation of the electronic signature with the secret key of a generator and in connection with the data set, the data sources and/or the data files or their hash code.

However, it is a disadvantage of this method, that it cannot be guaranteed that the thus electronically signed data sets, data sources and/or data files have not already been changed in any way. It is for example conceivable that a participant, a user, or a subscriber electronically signs data or data sources or data files without recognizing that these contain also additional undesired data, or that the participant, user, or subscriber signs, unbeknownst to the participant, user, or subscriber, only a part of the data set or data sources or data files.

### SUMMARY OF THE INVENTION

1. Purposes of the Invention

It is an object of the present invention to furnish a method, which assures that only uniquely identified or uniquely undisturbed data sets, data sources and/or data files are furnished with an electronic signature.

These and other objects and advantages of the present invention will become evident from the description which follows.

2. Brief Description of the Invention

The invention employs the following method steps.

The data sets, data sources and/or data files are entered, captured, and recorded another time as a graphical image. A defined transformation process generates a graphical image from the original form of the data set, data sources and/or data files in this process. If the original form of the data source or data file is for example a text data file, then the text data file is recorded as ASCII-similar data and/or data files (plus any control characters) according to the syntax of the employed text processing program. The data file can then be displayed or printed in this output form, in connection with corresponding graphic drivers or printer drivers, on the screen and at the printer. The areas, not used for displaying or printing out on the screen or on a printout, are not furnished in the data files in question.

In contrast, the original form of the data and/or data files is not seen as textual material but instead as an image in the preceding graphic image, which can be generated for example through a vector graphic procedure. Each individual point or dot of a character and each individual point or dot of a non-recorded area is defined as a graphic element and captured in this way. Consequently, only those elements are entered and recorded which are visible on the screen, such that hidden elements such as control characters, macros and the like, as they occur for example in text data files, do not become part of the graphic data file. A data set or data file can be thereby changed such that the size of the data set or of the data file remains unchanged. Changes can thus not be determined based only on the size of the date or of the data file. However, such changes generate a different representation on the screen or on the printer. Thus, they are visible and generate thereby a different image.

According to a further step, in each case a unique value is determined and recorded, for example the corresponding hash value, both for the original form of the data and/or data files as well as for their graphic image through a check sum procedure, which can for example be a hash method. The respective hash values are referred to in the following as the first electronic seal (from the original form of the data and/or data files) and a second electronic seal (from the image of the data and/or data files).

According to a third step, the original form of the data set and/or data files and their image, together with the two electronic seals, are transmitted to the receiver. It is apparent that also the original form of the data and/or data files or their image can be encoded for the transmission if this should be required.

According to a further step, the receiver generates with the same transformation process also an image of the data file from the original form of the data and/or data file, transmitted to him and possibly decoded again.

According to a further step, a third electronic seal is generated from this image of the data and/or data file according to the same method.

If the image of the original form of the data and/or data files, generated by the receiver, is identical to the image of the original form of the data file, generated by the sender, then the electronic seals, generated by the receiver with the same transformation process, must also be identical to that seal, which was transmitted to the receiver together with the data file. A deviation of these two electronic seals means that the image, generated by the receiver according to the same transformation process, is not identical with that seal, which was generated by the emitter or sender. The consequence is that also the received original form of the data file has to be changed. This holds even where the clear data file size value and/or the image of the sent original form and/or of the received original form of the data file are identical.

A complex transformation process can also comprise several parts. According to the present invention, individual seals can be generated for such parts and can be employed according to the present invention as are the previously described seals.

In addition, seals can also be generated to suitable components of the system environment, for example relative to running processes. The more seals that are generated according to the present invention and are employed, the more secure is the procedure.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWING

In the accompanying drawing, in which are shown several of the various possible embodiments of the present invention:

FIG. 1 is a view of a schematic diagram illustrating the method of secure display in connection with data transfer of the present invention.

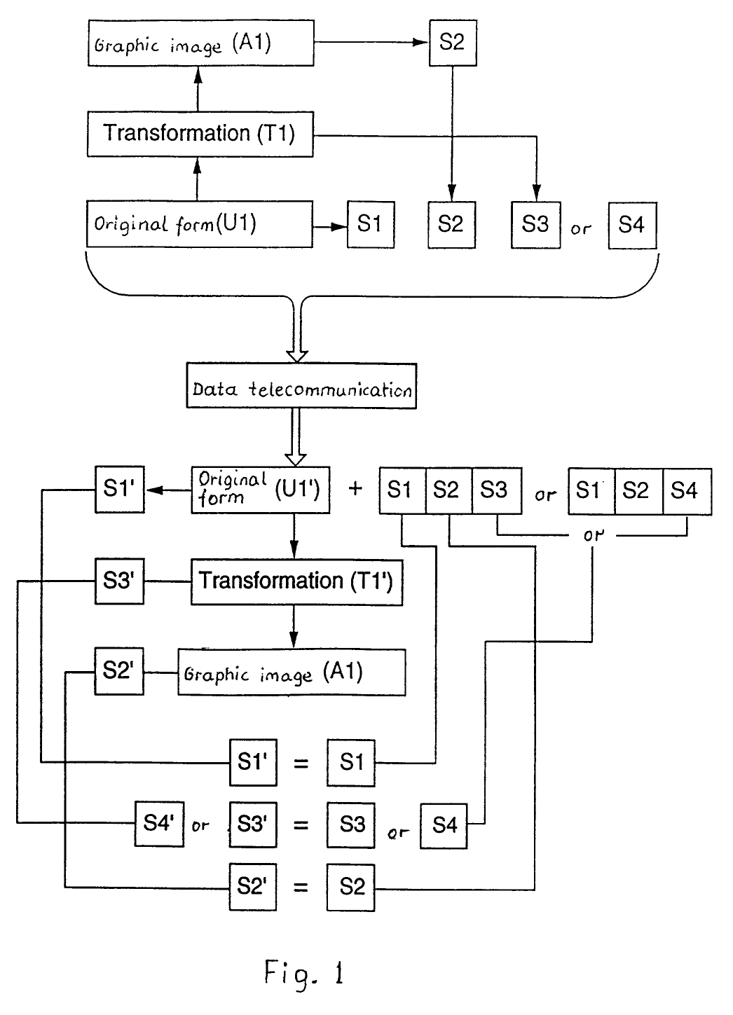

### DESCRIPTION OF INVENTION AND PREFERRED EMBODIMENT

The user has a first original form U1 of a data set or of a data file. For this purpose, the user generates a first electronic seal S1. The user generates a first graphic image A1 of the first original form U1 of the data in question or of the data file in question based on a first transformation process T1.

According to a further process step, a corresponding second electronic seal S2 is generated by the user from the first image A1. This second electronic seal S2 is connected to the first original form U1 in a suitable way, for example, it is attached by the user. The thus formed data packet (U1 plus S2) is then transmitted to the desired receiver.

The receiver can generate from the original form U1′, having been received at the receiver, again a second image A1′ based on the same transformation process T1′. In the following, the receiver generates a new a corresponding third seal S2′ based on the same process of the “further process step”.

If the original form U1′, received at the receiver, is identical to that of the first original form U1, which was sent out, then also the in each case generated seals S1 and S1′, or, respectively, S2 and S2′ have to be identical. Each deviation would be a proof for a deviation between the first original form U1, to be sent, and the received original form U1′,

In order to increase further the security of the method, a fourth seal S3 can be generated also by the transformation process T1, and the fourth signal S3 can be transmitted together with the first original form U1 to the receiver.

It is apparent that also the first original form U1, the corresponding seals S1, S2, and/or S3 can be transmitted separately to the receiver according to the present invention.

It will be understood that each of the elements described above, or two or more together, may also find a useful application in other methods for the secure transmission of data files differing from the types described above.

While the invention has been illustrated and described as embodied in the context of a method for the safe display during transfer of data or data files between users, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method for the secure transmission of data or data files between participants, subscribers, and users,
wherein a first graphic image (A1) of a first original form (U1) is generated from the first original form (U1) of the data file or of the data by a first transformation process (T1);
wherein a second electronic seal (S2) is generated from the first graphic image (A1) in a second step;
wherein the first original form (U1) of the data file or of the data and the second electronic seal (S1) of the first graphic image (A1) are transmitted to a receiver;
wherein the receiver generates a second graphic image (A1′) of the original form (U1′) received at the receiver with the same transformation process (T1′);
wherein the receiver generates a fourth electronic seal (S2′) from the second graphic image (A1′), generated by the receiver, based on the second transformation process (T1′);
and wherein the transmitted second is seal (S2) and the newly generated fourth electronic seal (S2′) are compared relative to each other with respect to identity.

2. The method according to claim 1, wherein a first electronic seal (S1) is the generated from the first original form (U1) of the data file or of the data;
wherein the receiver generates a third electronic seal (S1′) from the original form (U1′) received by the receiver; and
wherein the transmitted first seal (S1) and second seal (S2) and the newly generated third seal (S1′) and fourth seal (S2′) are in each case compared to each other with respect to identity.

3. The method according to claim 1, wherein
a fifth electronic seal (S3) is generated by the first transformation process (T1), which fifth electronic seal (S3) also is transmitted to the receiver;
wherein a sixth electronic seal (S3′) is the generated at the receiver by the second transformation process (T1′);
wherein the transmitted first, second, and fifth seals (S1, S2, and S3) and the newly generated third, fourth, and sixth seals (S1′, S2′ and S3′) are in each case compared to each other with respect to identity.

4. The method according to claim 2, wherein
in each case corresponding sixth electronic seals (S4) are generated by two or more parts of a first transformation process (T1) in connection with a first transformation process (T1) comprising several parts;
wherein in each case additional corresponding electronic seals (S4′) are generated at the receiver from two or more parts of a second transformation process (T1′) in connection with a second transformation process (T1′); and
wherein the transmitted first, second, and fifth seal (S1, S2, S4) and the newly generated third, fourth, and sixth seal (S1′, S2′ and S4′) are compared to each other with respect to identity.

5. The method according to claim 1, wherein a seal is generated from suitable components of the system environment, and wherein the transmitted seals and the newly generated seals are compared to each other with respect to identity.

6. The method according to claim 1, wherein the seals are transmitted separately from the first original form (U1) and/or the first graphic image (A1) to the receiver.
